(19) United States
(12) Patent Application Publication
(10) Pub. No.: US 2010/0198605 A1
(43) Pub. Date: Aug. 5, 2010

(54) Method for Structuring Balanced and Varied Meals

(76) Inventor: Gerard Saulet, Alfortville (FR)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 12/669,608

(22) PCT Filed: Jul. 18, 2008
(86) PCT No.: PCT/EP08/59420

§ 371 Date: Mar. 3, 2010

(30) Foreign Application Priority Data
Jul. 19, 2007 (FR) 0756610

(51) Int. Cl. G06Q 99/00; G06F 17/30

(52) U.S. Cl. 705/1.1; 707/802; 707/E17.044

(57) ABSTRACT

The present invention relates to a method for structuring balanced and varied meals, and this method is characterized in that a database is constructed comprising all the varieties of dishes available during a given period, as well as the characteristics of their constituents, in that those dishes complying with the food restrictions relating to this user and constituting a balanced meal are selected from this database, for each meal, from among the available dishes, and in that the user chooses from among these dishes those that he or she prefers. The database consists of references of ingredients, of recipes, of dishes and of meals that are pre-established. These references are characterized in that each of the constituents of this database is coded as a function of its nutritional, therapeutic, budgetary properties, target consumers, etc. The filter of the database is formulated dynamically on the basis of the prior information and with the aid of the codes of the dishes (or meals). Stated otherwise, the inputting of the prior information serves to define requests.

The present invention pertains to a method for structuring balanced and varied meals.

The catering market is rich in the diversity of cases of application in respect of collective communities. Indeed, those in charge of communal catering encounter very variable degrees of difficulty depending on the public concerned. Among these collective communities may be mentioned:
schools,
clinics, hospitals, and retirement homes,
the army,
municipal restaurants,
company restaurants,
large “self-service outlets”,
kitchens of boats and floating barges.

Malnutrition is due to poor food hygiene caused by general ignorance of the minimum rules of dietetics, the loss of the tradition of regional rules of nutrition, nutritional slide due to the proliferation of new foods and precooked dishes, the abuse of fast food cooked in microwave ovens, the fashion for poorly controlled slimming diets, etc.

The results of this malnutrition are, inter alia, and depending on the country, increases in:
obesity: more than 17% of children are obese (the obesity curve being comparable with that of the United States in the 1980s),
serious diseases (like cancers),
absenteeism due to illness,
etc.

The information available, in particular to the general public, is the following:
Books: this static information and more often than not intended for the initiated, or indeed for professionals, is valuable, indispensable, but insufficient to allow the general public to balance their meals by themselves.
Software: software exists for aiding nutrition, but the daunting aspect of its use and the complexity of the information managed demand a thorough knowledge of nutrition. Furthermore, such software generally offers only a choice of dishes as a function of the set price of a meal, but does not make it possible to put together meals taking into consideration various dietary and nutritional restrictions.
Televised broadcasts: although the topic is featured in certain broadcasts, the discussions still remain superficial and present only restricted views of a very complex topic which is insufficiently studied in its global interactions.
Conferences: they are attended only by the initiated and by professionals, since the knowledge demonstrated there is inaccessible to novices.

The subject of the present invention is a method for structuring balanced and varied meals, of good gustatory quality, taking account of the fashions and conditions of life of the users, of their allergies, of their religious prohibitions and principles, it being possible for this method to be implemented both by users such as catering establishments or collective communities (restaurants, company canteens, hospitals, etc.) for their customers who are the consumers of these meals and directly by consumers such as individuals at home, and allowing the formulation of a healthy diet, while having the ambition of helping not only to arrest but to reverse the current tendencies toward malnutrition by best meeting the actual requirements of all individuals, while constantly benefiting from the latest discoveries with regard to nutrition. The subsequent description will deal essentially with consumers, it being clearly understood that this term can also refer to users implementing the method for their consumer customers. The object of this method is also to:
Allow those in charge of social or commercial catering, and also individuals, to formulate, without prior knowledge of nutrition, balanced and varied meals with the aid of a computer-based tool which is easy to operate and accessible through the Internet (or indeed intranet for large establishments),
Make the school meals menu available by Internet, to the parents of pupils,
Promote local agricultural production by creating and managing networks of agricultural producers, preferably near to the places of consumption,
Set up pilot sites to validate the relevance of the method, analyze changes, note trends, verify in the field the soundness of the recommendations, etc., that is to say establish links between “laboratory research” and “field research” and draw up a blueprint to be complied with by the producers of products involved in the composition of meals,
Make it possible to create a recognized international quality label upheld, inter alia, by the State,
Pass the information between research centers (such as the CNRS, INSERM, INRA, in France) and take into consideration “independent” experiences (establishments, towns or regions),
Pass on the “teachings” of professionals in the health, food and other sectors able to contribute directly or indirectly to the “reversing” of obesity and chronic illnesses,
Popularize the minimal knowledge in nutrition with suitable language accessible to all,
Catalog by geographical sectors all the practitioners who can contribute to the improvement of health through diet. Provide “full public” access through the Internet to their particulars and specialty,
Assist teachers in public or private schools with the aid of paper, multimedia or Internet media, or indeed by putting them in touch with nutrition professionals,
Aid disadvantaged families to administer the allowances paid by social services by allocating children “electronic purses” reserved for the use of school restaurants,
Make “role games” accessible through the Internet with the objective of sensitizing the entire public to the importance of a healthy diet and respect for the environment,
Etc.

Methods for preparing dietary meals which either call upon specific algorithms that are difficult to upgrade, or do not allow fine customization of meals, are known from the documents US 2002/042745, WO 2006/038820 and US 2007/143126.

The objective of the invention is therefore to reach all professionals in the food, agriculture and health sectors, as well as the entire public and by every means.

According to the method of the invention, a database is constructed in a computer by having a (or several) specialist(s) code each dish finalized as a function of the properties of its constituents, these properties being defined and allotted by the specialist(s) who takes (take) into consideration the characteristics of the target consumer(s), the database comprising a whole variety of dishes which will be available during a period relating to the season, as well as the characteristics of their constituents, then the computer selects from this database, for each meal, from among the available dishes, those complying with the food restrictions relating to this (or these) consumer(s) while making it possible to construct a balanced meal, and the consumer chooses from among these dishes those that he or she prefers.

According to an advantageous characteristic of the invention, this method is characterized in that first a database of recipes, dishes and meals is constructed by carrying out the following steps:
A specialist codes the culinary properties of the ingredients usable in recipes and their possibilities of association with other ingredients or the ingredients of other recipes,
A specialist codes the proportions of the various ingredients of the recipes, the cost of the ingredients of these recipes and the preparation times,
A specialist codes the various dishes produced on the basis of elementary recipes or complex recipes, the resulting code comprising at least one item of information about nutrition and availability and the possible associations with respect to the other dishes of one and the same meal,
A specialist codes typical meals on the basis of a major component or dish,
A referential database is thus obtained and stored in a computer, and thereafter:
The consumer(s) is (are) authenticated by the computer,
A filter defining the requirements of the consumer(s) and constraints is created by this computer,
The filter is applied by the computer to the database,
The computer offers the consumer thus authenticated a choice of dishes meeting said constraints relating to the consumer(s) and optimized in terms of dietary and nutritional values.

Of course the specialists mentioned above can be one and the same person or else different people specializing in the respective domains (cookery, dietetics, nutrition) and able to perform the corresponding coding operations.

According to a characteristic of the invention, the constraints relating to the consumer comprise at least one of the following constraints: nutritional, dietary, cost price, recommendations and therapeutic counter-indications, preferences, his state of health, changes in his state of health, the record of his last n meals, n advantageously being equal to or greater than 8.

In an advantageous manner, the selection of dishes from the database is subordinated to the consideration of prior information comprising at least one of the following items of information: country, region, date of meal, type of meal, number of meals for omnivores, number of meals for vegetarians, restrictions (because of beliefs, taste or allergies), group of individuals.

Also in an advantageous manner, the referential database evolves as a function of at least one of the following parameters: the latest dietary, nutritional or therapeutic discoveries, new methods of preparation or cooking, changes in the availability of commodities.

Thus, by virtue of the invention, a perfect fit is obtained between the end user, the consumer(s) and the various available ingredients corresponding to the requirements. This is achieved in particular by virtue of the fact that the application generates by human intervention the key for coding the recipes and dishes, that is to say the key is specific to the finalized dish and is dependent on the properties selected by the specialists (nutritionists, dieticians, chefs). This key therefore makes it possible to take into consideration a large number of criteria to customize a meal. For example, this key can be dependent on a blood group, morphological properties of the consumer(s), his preferences or his counter-indications. This coding thus makes it possible to offer the user a large variety of dishes that can easily change according to the seasons, the availabilities of ingredients, the most recent discoveries in nutrition or changes in the state of health of the user and in his nutritional requirements as a function of the changes in this state of health. Because the key is generated by human intervention, the latter can change as a function of developments in knowledge, even if only with regard to just one of the properties allotted to the recipe or to the dish at an instant “t”.

The present invention will be better understood on reading the detailed description of an embodiment, taken by way of nonlimiting example and illustrated by the appended drawing, in which:

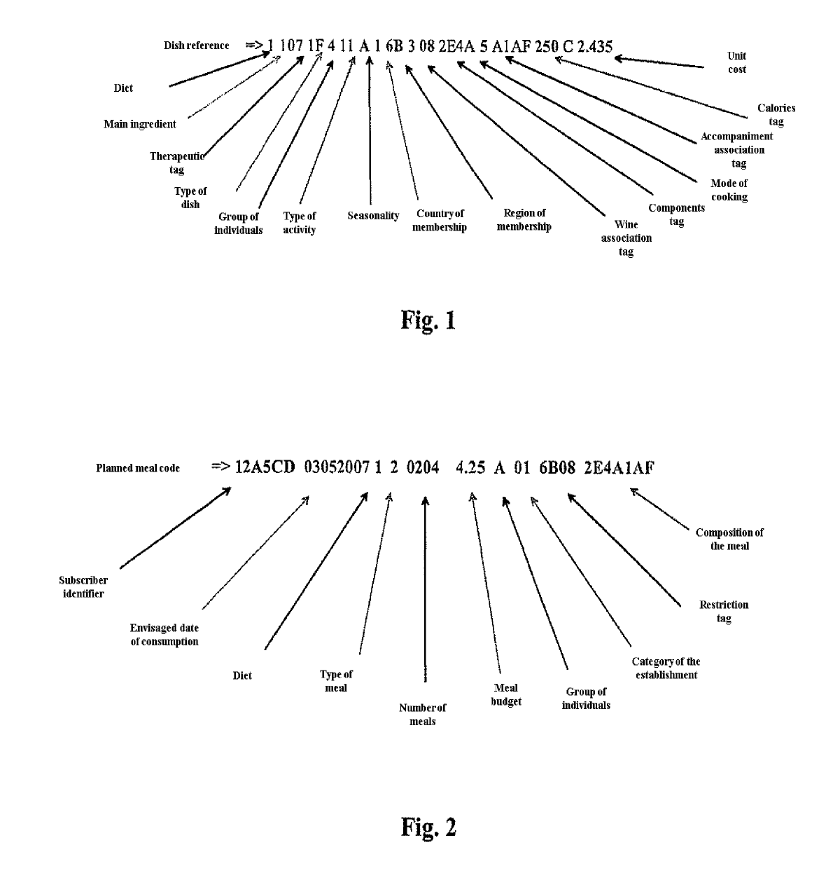

FIGS. 1 and 2 are simplified examples of codes of dishes and of meals obtained according to the method of the invention.

One of the essential phases of the invention being the successive coding of the ingredients of meals, recipes, dishes and typical meals, a preferred mode of implementation of the coding method of the invention will be set forth with reference to FIG. 1 of the drawing.

The method of the invention is implemented with the aid of a computer, such as a personal computer comprising a database management tool and linked to a display screen, for example a touch screen by virtue of which the user makes his choices in the manner set forth below. In an advantageous manner, only the information required by the consumer is displayed on this screen. When the process for constructing a meal, described below, is completed, this computer orders the display of the dishes thus chosen on an appropriate screen which is read by the personnel responsible for preparing and/or delivering these dishes to the user. This computer is advantageously linked to a computer-based network (Internet or intranet for example), which makes it possible to update the database remotely, to organize forums between nutrition specialists, to manage a chain of restaurants or canteens, etc. As a variant, this computer can be disposed in a management center and be linked by Internet link not only to communal catering establishments, but also to the residence of particular consumers. In an advantageous manner, a management center is installed at a chosen site of each region of a country, and a central site linked to all the regional sites. The updates of references or of prices (for example) are subject to validation and therefore pass through the central site which forwards these updates to the other sites after approval from the manager in charge of the central site.

The database in accordance with the invention is constructed in the following manner.

To construct this database, “elementary” recipes, “complex” recipes, dishes and meals are coded, relying on the expertise of specialists in nutrition (nutritionists, dieticians, naturopaths or naturotherapists, etc.), notably as a function of the following criteria:
Diet (omnivorous, vegetarian or common),
Main ingredient tag (“encapsulated” code),
Therapeutic tag (disease correspondence —“encapsulated” code),
Type of meal (breakfast, lunch, afternoon tea or dinner),
Group of individuals (for example: less than 3 years, 3-7 years, 7-11 years, 11-15 years, 15-19 years, . . . , etc.),
Type of activity (sedentary, low physical activity, average physical activity, high physical activity, sporting),
Season (spring, summer, fall, winter),
Country of membership,
Region of membership
Wine association tag (“encapsulated” code),
Components (dishes, recipes, elementary recipes —“encapsulated” code)
Mode of cooking
Quantity of calories
Unit cost, etc.

When formulating a meal, and as a function of the planning, the following are added to the previous coding:
Establishment tag (restaurant, company canteen, etc.),
The dishes are diversified by consulting the records of consumed meals.
Date of planning of the meals (for example up to a month in advance), so as to allow, especially communal restaurants, to optimize the costs of purchasing the ingredients for their meals,
Aversion tag(s) (association of a main ingredient with a mode of preparation —“encapsulated” code)
Allergy tag(s) (“encapsulated” code).

The concept of “encapsulated code” within the meaning of the present invention indicates that the code makes reference to other combinations of codes. Of course, in the present example, the wordings of the codes are arbitrary, and they could be worded in numerous other ways which are obvious to the person skilled in the art on reading the present description. Code 107 such as represented at the start of the dish code of FIG. 1 has been detailed below.

| | | |
|---|---|---|
| | 1A Sugar crust pastry | 3C Wheat flour |
| | | 40 Hen's eggs |
| | | 51 Soft butter |
| | | B5 Salt |
| | F2 Apple compote | |
| | 22 Golden delicious apple filling | |
| 107 = Apple => | | |
| | 05 Apple-cinnamon topping | 67 Apple pips |
| | | B2 Cinnamon spice |
| | | etc. |
| | B2 Cinnamon spice | |

In this example, the encapsulated code 107 makes reference to the codes of preparations 1A, F2, 22, 05, B2 as well as to the codes of basic ingredients 3C, 40, 51, B5, 67, B2.

The “Main ingredient” code can be a part of the “Component Tag” code.

All the elements of the database are coded according to this principle: meals, dishes, recipes, elementary recipes (which are basic recipes such as sweet pastry for example), ingredients, therapeutic properties, allergies, modes of cooking, of storage, etc., that is to say any information that has some relevance to the construction, preparation, recommendations, etc. up to the monitoring of consumer satisfaction.

The computer-based tool for formulating the meals operates in the manner of an expert system and therefore uses all these codes to construct the meals according to the following process:

First of all, it takes into consideration the prior information relating to the user and to the place of delivery of the meal, such as country, region, date of meal, type of meal (omnivorous meal or vegetarian meal), restrictions (because of beliefs, taste or allergies), group of individuals, etc. In an advantageous manner, this prior information is stored in the memory of a medium such as a memory card (or “smart card” of credit card type) belonging to the user and which he inserts into an appropriate terminal, linked to said computer managing the database. This memory medium can advantageously serve him as a means of paying for his meals (that he replenishes as and when necessary). As a variant, this prior information is stored in the computer (with that of all the other potential users of this computer-based tool) and the user wishing to construct his meal with this tool enters his personal code with the aid of a keyboard (or other input or identification peripherals) linked to the computer, the effect of which is that the prior information is automatically taken into consideration and the process for constructing a meal and delivering the dishes of this menu is activated.

Thereafter, the user makes his choices in the following manner, but of course the user can skip some of the steps below if he wants to choose an incomplete menu. Also, the list of choices below can of course be modified according to the features of the place or country where this meal is eaten (for example, step 4 below of choosing a cheese can be eliminated if in the country in question cheese is never consumed, or else other steps can be added):

1—Choice of a main dish. It is, preferably, the choice of the main dish that determines the subsequent selections. The selection of this main dish is added to the prior information taken into consideration previously and suggests the next choice.
2—Choice of the accompaniment. The selection of this accompaniment is added to the previous considerations and suggests the next choice.
3—Choice of the first course. The selection is added to the previous considerations and suggests the next choice.
4—Choice of a cheese and/or a salad. The selection is added to the previous considerations and suggests the next choice.
5—Choice of a dessert.

According to an important characteristic of the invention, the selections and choices are interdependent: each choice depends on the previous selection and this also implies that the calling into question of the choice of the accompaniment (for example), although the dessert has just been chosen, causes all the succeeding choices to be called into question. Stated otherwise, when a selection is canceled, all the succeeding selections are canceled.

This coding principle therefore makes it possible to use all the work carried out by nutritionists, dieticians, researchers, etc.

The implementation of the method of the invention relies above all on a computer-based tool, preferably accessible by Internet or intranet. The latter is composed of a standard module managing the database and of optional modules having to precisely meet everyone's requirements and managing certain parts of the code, as set forth in greater detail below.

A characteristic of the invention is that, for each screen page, the amount of information visible to the end user is reduced to what is essential, doing so in simple language. This is achieved, as set forth in greater detail below, by inputting the prior information, to which is added the consultation of the records, thereby generating a request making it possible to display the useful information alone.

Access to the data is contingent on the profile of the users. Thus, the data, complex or otherwise, but pertaining to nutrition, are visible only to nutrition researchers or professionals. The data pertaining to culinary preparation are accessible to chefs. The data corresponding to budgetary aspects are accessible to supervisors (or financial managers, etc.).

The computer implementing the method of the invention can advantageously also be used to manage any catering establishment, for example to manage and optimize stocks, orders for products for meals, etc.

Beyond the feature of the screen pages of the “portal” and Internet sites, the application can be divided up into a standard version and extended versions corresponding to the options chosen, corresponding to the optional modules.

The filtering of the useful data is made possible by the very principle of the coding of the recipes and dishes. To arrive at this coding, the nutrition professional must define, beforehand, all the nutritional and therapeutic properties of these recipes or these dishes with the aid of a referential grid of the type of that represented in the chart below. This phase is crucial to the correctness of operation of the expert system, this being the reason why this phase is carried out by recognized nutrition experts who take on the responsibility for assigning these properties.

Represented below are an arbitrary and very simplified example of a referential identification grid (Chart 1) followed by an equally arbitrary and simplified example of a grid for identifying the properties of a dish (Chart 2):

CHART 1

| Referencing wording | Possible codes | Corresponding properties |
|---|---|---|
| Country of membership | 1 | France |
| Country of membership | 2 | European country |
| Country of membership | 3 | Asia |
| etc . . . | | |
| Region of membership | 00 | All regions |
| Region of membership | 01 | Mediterranean region |
| Region of membership | 02 | North region |
| etc . . . | | |
| Diet | 0 | Neutral |
| Diet | 1 | Omnivorous |
| Diet | 2 | Vegetarian |
| . . . | | |
| Type of dish | 1 | Breakfast |
| Type of dish | 2 | Lunch |
| Type of dish | 3 | Afternoon tea |
| Etc . . . | | |
| Main ingredient | 001 | Potato |
| Main ingredient | 002 | Turnip |
| Etc. | | |

All the criteria being thus defined, the nutrition professional can then use a referencing module (which is a software module implementing the four phases of the first step, described below, following Chart 2) to carry out this coding. Thus, for example, for a dish comprising a red meat, it would be possible to have as properties those listed below in Chart 2.

CHART 2

| | Property | |
|---|---|---|
| Referencing wording | Code | Comments |
| Country of membership | B | All countries except India |
| Region of membership | 00 | All regions |
| Diet | 1 | Omnivorous |
| Type of dish | 2 | Lunch |
| Main ingredient | 107 | Fillet of beef |
| Components tag | 2E4A | Shallot sauce |
| Accompaniment | A1AF | Group comprising green beans, |
| association | | steamed courgettes, Group |
| tag | | comprising potatoes, etc. |
| Wine association tag | 08 | Red wine from Cahors |
| Therapeutic tag | 1F | Convalescent exclude digestive |
| | | system. |
| Group of individuals | 4 | consumers more than 7 years old |
| Type of activity | 11 | |
| Seasonality | A | |
| Calories tag | 250 | |
| Unit price tag | 2.435 | or the price bracket to which the |
| | | dish corresponds |
| Etc. | | |

According to an important characteristic of the invention, the first step of preparing the information to be stored in the databases comprises several phases, which are the following:

Phase 1
Following his customary working schemes and for a given requirement (a young woman who has just given birth for example, etc.), the nutrition professional defines the component of the dishes from which a meal will be put together. For this purpose he uses standard database operating software (such as “Access” or “MySql”). He will therefore have put together, for a meal, at the minimum a first course, a main dish and a dessert which will meet the specific requirements of a woman who has just given birth (in the aforementioned example).

Phase 2
The nutrition professional sends the composition of the meals obtained in phase 1 to the chef who will, while complying scrupulously with the instructions of the nutrition professional, formulate the descriptions of the corresponding recipes (stated otherwise, the chef will design and then draft the directions for the recipe corresponding to the instructions of the nutrition professional). The documents describing the way to carry out the recipes thus formulated are archived and identified with the aid of an identifier which can be chronological (what is important is only that it is unique).

Phase 3
The nutrition professional identifies the properties of each dish and of each recipe with the aid of the reference for identifying the type of that of Chart 2. It indicates, for each recipe referenced, the identifier of the corresponding recipes which have been formulated by the chef.

Phase 4
The nutrition professional uses the referencing module to code the dish or the recipe, based on the work of the previous phase. The following information is then stored in the database:
   The code of the dish or of the recipe,
   The recipes with their inherent identifier, their detailed description, or indeed their animation (if an animated or filmed presentation is envisaged),
   The list of the ingredients corresponding to each recipe

It is only after this fourth phase that the recipe is usable by the expert system and that the information thus formulated is stored in the databases.

The referencing module has created a link between the code generated, the identifier of each recipe and between the ingredients of the list of ingredients.

This operating mode allows notably communal catering companies to dispense with the first two phases. It is then their products which are referenced by using the criteria of the invention, and then coded by the nutrition specialist.

This referencing and codifying step being implemented with the aid of a first computer-based tool, it is then possible to use a second computer-based tool, which is the aforementioned standard module, and which may be an expert system such as that mentioned in the following explanations, to proceed to the second step, that is to say to undertake the formulation of the compositions of the meals and their planning

The first tool, which is the referencing module, is a wholly separate tool which can be implemented on different machines from those used by the expert system. It is however accessible through the same Internet site for authorized users. The second tool is actually the expert system itself.

In this second step, the composition of a meal is formulated in the following manner:

Phase 1
The user wishing to choose a meal is identified on the system implementing the invention (for example by using a terminal keyboard linked to a management center) with the aid of an identifier and of a password,
The identification is made on the Internet site and is a prerequisite to the use of the services offered. This identification is carried out by a specific function, which, beyond the “login” (identification) and the password, and according to the desired security level, can be enhanced with complementary checks such as a reader of prints, a DNA identifier or some other comparable system.

Phase 2
The system verifies the user's personal information (this information is linked with the access rights and comprises a part of the information prior to the formulation of a meal). This information being static, it is displayed by default when the user logs on. It is important that the user verifies its accuracy and then validates or corrects this information if appropriate.

Phase 3

The user enters the complementary prior information, namely:
Country,
Region,
Date of the meal concerned,
Type of meal,
Number of omnivorous meals. If, by way of example, (to address the diversity of the clients), it is considered that out of a hundred individuals who wish to have a meal, there are eighty who are omnivorous and twenty who are vegetarian, then eighty omnivorous meals and twenty vegetarian meals are provided for one and the same date and for one and the same subscriber.
Meal budget per person for omnivores,
Number of vegetarian meals,
Meal budget per person for vegetarians,
Category to which the clients belong,
Category of the establishment,
Comments

Phase 4
The user enters the dietary and other restrictions according to the following model:
   Meat,
   Mode of preparation based on meat,
   Number of meals pertinent to the meat restrictions
   Fish,
   Mode of preparation for fish,
   Number of meals pertinent to the fish restrictions,
   Allergy (allergies),
   Number of meals pertinent to the allergy (allergies)
   Observations

Phase 5
Proceed to the actual formulation of the meal. The expert system (the computer) takes all this information into consideration, consults the archives of the meals which relate to the subscriber, and then formulates a filter for the database so as to extract therefrom a first list of choices. This first list of choices relates to the “main” dish. The user selects a dish from among the list of available main dishes that meet this user's characteristics. This choice determines the next choice.

Phase 6
The expert system (or computer) adds the selection of the “main” dish to the prior information, to the indicated restrictions, a new consultation of the subscriber's meals archives is carried out and then a new filter on the database is formulated so as to extract therefrom a new list of choices. This second list of choices relates to the accompaniments. The user selects a dish which will determine the next choice.

Phase 7
The expert system (or computer) adds the selection of the “accompaniment” dish to the prior information, to the indicated restrictions, to the selected “main” dish, and carries out a new consultation of the archives relating to the user's previous meals (it is assumed here that the user has previously used this same expert system (or computer)) and then applies a new filter to the database so as to extract therefrom a new list of choices. This third list of choices relates to first courses or soups. The user selects a dish, and this will determine the next choice.

Phase 8
The expert system (or computer) adds the selection of the first course or soup to the prior information, to the indicated restrictions, to the selected “main” dish, to the selected “accompaniment” dish, and carries out a new consultation of the archives of the user's previous meals, and then applies a new filter to the database so as to extract therefrom a new list of choices. This fourth list of choices relates to “cheeses”. The user selects from this list a dish which will determine the next choice.

Phase 9
The system adds, if appropriate, the selection of the cheese (which is optional) to the prior information, to the indicated restrictions, to the selected “main” dish, to the selected “accompaniment” dish, to “the first course” or to the “soup” selected, carries out a new consultation of the archives of the user's previous meals, and then applies a new filter to the database so as to extract therefrom a new list of choices. The latter list of choices relates to “cheeses”. The user selects a dish, and this will conclude the step of formulating the meal by printing out a summary of the meal with all the information pertaining thereto.

If, during the various phases, the user notices an error or calls into question a previous choice, the method for formulating the meal resumes at the phase in which a modification has taken place.

Depending on the options to which the restaurant manager has subscribed, certain phases may be deleted, or else additional phases may be inserted between the phases indicated above, the amount of prior information may be greater and the subsequent steps may vary.

If we confine ourselves for the moment to the use of the standard module of the expert system, the next step is the printout of a list of requirements in terms of ingredients with quantities relating to conventional packs marketed in volume retailing. On the basis of the subscriber's personal information, a list of local approved distributors or those that are closest using the method of the invention is printed out in parallel.

It is of course possible to aggregate the requirements in terms of ingredients of each meal planned over a determined period, so as to optimize costs.

The output code from the formulation of the meal, that which will be archived as a record in the subscriber's account, is structured in the following manner:
Subscriber identifier
Envisaged date of consumption of the meal (if provision is made to take into consideration omnivorous meals and vegetarian meals, there is one envisaged date of consumption for two or more meals).
Diet,
Type of meal
Number of meals
Budget for the meal
Category to which the clients belong
Category of the establishment
Restriction tag (zero if no restriction, encapsulated code if detail of restrictions),
Composition of the meal (encapsulated code).

An arbitrary example of a meal code thus formulated has been represented in FIG. 2. This planned meal code is temporary and its lifetime is limited to that for which the records relating to the user in question are retained.

The code of a “typical meal” is very close to that described previously apart from the following exceptions:
It does not include an “envisaged date of consumption”, but a seasonality indicator,
It does not include a “subscriber identifier”, but a “country code” and a “region code”,
It does not include a “number of meals”,
It does not include a “restriction tag”.

The code of a “customized typical meal” is supplemented with codes or tags corresponding for example:

To a disease,

To restrictions,

Etc.

The proposals for typical meals are always conditioned by the consultation of the subscriber records to ensure diversity of the meals.

The system of the invention can also comprise optional modules such as those described below:

For the catering part:
Module for complying with gustatory preferences and aversions. The objective here is to optimize the meal/individual fit. This module supplements the management of the restrictions of the standard module and is mainly intended for commercial catering. This module adds a “gustatory preference” tag (encapsulated code) to the planned meal code.
Module for managing the psycho-morphological profiles of the clients. Its objective is to optimize the meal/individual fit. This module supplements the management of the categories of individuals of the standard module and is mainly intended for health professionals or health establishments. It uses a “Psycho-morphological profile” code integrated into the recipe code (or the dish code) when this recipe (or dish) is referenced by the nutrition professional.
Module for managing the therapeutic properties of the foods and dishes. Its objective is to make it possible to affect the health by using the natural therapeutic properties of foods. This module supplements the management of the categories of individuals of the standard module and is mainly intended for health professionals or health establishments. It uses a “Therapeutic property” code integrated into the recipe code (or the dish code) when this recipe (or dish) is referenced by the nutrition professional.
Module for customizing the meals by individual. Its objective is to optimize the precision in the Meal/Individual fit. This module supplements the management of the categories of individuals of the standard module and is mainly intended for health professionals or health establishments. This module allots a personal identifier to a client and is integrated into the meal code.
Module for archiving the pre-established customized meals. Its objective is to facilitate the programming of the meals. This module supplements the management of the meals of the standard module and is mainly intended for social catering. This module generates a meal code as described above.
Module for archiving pre-established dietary rebalancing programs. Its objective is to enrich the referential meal bases. It supplements the management of the pre-established “customized typical meals” of the previously described module and relies on the customized monitoring module described below. It is mainly intended for health professionals or health establishments. This module uses the personal dossier to monitor the rebalancing. The meals proposed by this module are customized and structured to address a controlled progressive therapeutic requirement.
Module for managing customized monitoring dossiers. Its objective is to ensure customized monitoring of clients (health establishments, retirement homes, etc.). It supplements the management of the categories of individuals of the standard module and is mainly intended for health professionals or health establishments. This module allots a personal dossier identifier which supplements the subscriber's identifier. This personal dossier can comprise nutritional instructions from the nutrition professional, linked with a medical dossier.

For the administrative part.
Chip card-based electronic purse management module. Its objective is to afford better control of attendance and the payment of benefits. This module supplements the management of the meals of the standard module and of the module for managing sales and invoices. It is intended for all types of catering. It uses an electronic purse management application such as exists on the market. Note that it is possible, on the same chip card (or other medium of the same type), to manage the electronic purse functionality jointly with the management of personal information relating to its owner's diet.
Module for managing orders. Its objective is to automate organizational processes. This module deputizes for the functionality for printing out lists of the requirements in terms of ingredients of the standard module. It is intended for all types of catering. This module uses an orders management application such as exists on the market, but interfaced to address the specifics of the method of the invention. In this module, the list of supplier prices is updated half yearly and is specific to each regional site. The update is transmitted in electronic format to the “webmaster” of the site who ensures that it is disseminated after validation. Monitoring of supplier approvals is also integrated into the module.
Module for managing stocks. Its objective is to automate organizational processes. This module deputizes for the functionality of printing out the list of requirements in terms of ingredients of the standard module and supplements the orders management module. It is intended for all types of catering. This module uses a stock management application such as exists on the market, but interfaced to address the specifics of the method of the invention.
Module for managing the natural degradation of the nutritive values of foods. Its objective is to make it possible to ensure higher precision in the management of the nutritional properties of the proposed meals. This module supplements that for managing the stocks. It is intended for all types of catering. It manages the information relating to the conditions and modes of storage, to the nature of the foods so as to define an advantageous period of consumption thereof (optimum nutritional values). This indication prevails with regard to quality over the consume-by date, the latter meeting health and safety standards. This functionality, which entails perfect stock keeping, generates an alert during the formulation of the meals if it is not complied with.
Module for considering last minute constraints. Its objective is to enable managers of the system to benefit from promotional supply conditions. This module supplements the management of the meals of the standard module. It makes it possible to take into consideration last minute constraints (delivery delay, promotional operation by suppliers to shift excess stocks, etc.) and to propose substitute dishes so as to address the same requirements and the same constraints. This module relies on the meal codes, the dish and recipe codes, on the records and on the stock management to formulate a filter on the database.
Module for managing sales and invoices. Its objective is to automate organizational processes. This module supplements the management of the meals of the standard module and the electronic purse management module. It is mainly intended for commercial catering. This module uses a sales and invoices management application such as exists on the market, but interfaced to address the specifics of the method of the invention.
Module for handling and automating accounting entries. Its objective is to automate organizational processes This module supplements the management of the meals of the standard module, the management of orders, the management of stocks, the electronic purse management and the module for managing sales and invoices. It is intended for all types of catering. This module uses an accounting management application such as exists on the market, but interfaced to address the specifics of the method of the invention.

For the individual.
Module for managing the possibility of controlled access to the site implementing the method of the invention for those close to the clients of the member establishments. Its objective is: To allow parents of pupils (for example) to formulate family meals compatible with those served within the member school establishments, doing so under preferential conditions. This module supplements the management of the meals of the standard module and is mainly intended for social catering. Accessible on identification, this module proposes the structuring and the programming of meals (together with the recipes) that are compatible with the meals served in the restaurants practicing the method of the invention. It uses the functionalities of the standard module.
Module for managing the interfaces dedicated to large retail outlets. Its objective is to allow customers to provide meals on the basis of products retailed in these large outlets, to allow large outlets to adapt their products as a function of their customers' expectations. This module resumes the management of the meals of the standard module and is mainly intended for retail distribution. It is accessible through the Internet (on the trade sites of large retail outlets) or on interactive stations. This module proposes meals (with the recipes) with the functionalities of the standard module, except that the proposals for dishes rely on products meeting the criteria of the method of the invention and sold in the large outlet concerned.

For the equipment.
Module for managing lightweight terminals. Its objective is: To facilitate the collection of information from clients within the framework of the forecasting of meals (option dedicated mainly to health establishments). This module supplements the management of the meals of the standard module and of the module for managing the customized monitoring dossiers. The information is transferred by radio link, “WIFI” or “Bluetooth” for example (or other similar technology), rapidly and easily activatable and deactivatable.
Module for driving and managing the network communications. Its objective is to facilitate the collection of information from clients within the framework of the forecasting of meals (option dedicated mainly to health establishments). This module supplements the module for managing the lightweight terminals described above. It allows information transfer in both directions (“push” and “pull”) and is done by radio link, “WIFI” or “Bluetooth” for example (or other similar technology), with a suitable security level.

For nutrition professionals.
Module for general practitioners. It makes it possible to afford access to services for patients of these practitioners so that they can program their meals themselves while allowing the practitioners to consult the consumption records during surgery visits or indeed to supplement meal intake with customized instructions.
Module for multicriteria choices of recipes. Its objective is to optimize the precision in the meal/individual fit. This module is a tool complementary to that of “pre-input of new projects for recipes”. It is intended for recording composite recipes and dishes. It makes it possible to search for elementary recipes that meet defined criteria such as diseases or the like and to integrate them into new recipes or into dishes.
Module for pre-inputting new recipe projects. Its objective is to enrich the referential bases of recipes. This module is a recipe recording tool. It makes it possible to draft and to present the recipes so that they can be used by chefs. It is only after this step that it will be possible for the nutrition professional to undertake the codifying of these recipes.
Module for referencing new recipes and new dishes. Its objective is to enrich the referential bases of recipes and dishes. This module is the key tool for codifying recipes and dishes. It uses the coding method of the invention.

Another characteristic of the invention pertains to the monitoring statistics tool. If this tool is the raison d′etre of the pilot sites, it may advantageously be a “navigation” system, very useful for any restaurant manager, supervisor or public community manager.

It is by virtue of this tool that it is possible to allot the “scores” of dietary and/or nutritional value, or indeed gustatory value.

Indeed, it is not certain that one and the same dish, prepared in different locations, although on the basis of one and the same recipe, will achieve the same result. The preparation and presentation depend on the chefs and the means available to them (technical, financial or organizational). The assessment of these same dishes may also differ on account of population diversity.

To summarize, the main advantages and characteristics of the method of the invention are the following:
Ease of use (without professional language), making the system accessible to all,
Guaranteed nutritional balance,
Diversity of meals in social or commercial catering and for member individuals,
Functionalities (as standard or optional) allowing it to address the most conventional requirements as the most demanding with regard to customization (customization ranging from the group of individuals to the personalized meal).
Functionalities (as standard or optional) allowing it to address the most conventional requirements as the most demanding with regard to organization.
Functionalities (as standard or optional) allowing it to address the most conventional requirements as the most demanding with regard to commercialization of “meals benefits”.
Good information about the menus of meals served in the member school restaurants, for the parents of pupils,
Management as standard of omnivorous diets and of vegetarian diets,
Management as standard of allergies,
Management as standard of the seasonality of products,
Management as standard of religious obligations,
Aid to disadvantaged families by offering public bodies, municipalities and restaurants the management of electronic purses reserved for catering and into which it will be possible to pay the allowances dedicated to this use.
Possibility of giving preference to local suppliers. Alongside the construction of networks of suppliers undertaking to implement the method of the invention and to comply with the commitments thereof regarding quality, it will be possible to gain acceptance of the quality of the products from these suppliers and to propose them by priority.
Validation on pilot sites of the positive impact of the method of the invention on health and its contribution to establishing links between laboratory research and field research. The objective being that this validation results in the recognition by the state of a quality label.
Possibility of promoting inter-communication between research centers such as the CNRS, INSERM, CNAM, INRA, INA-PG (to mention only French bodies).
Consideration of the results of some of the work of these research centers and of the independent experiences of establishments, towns or regions so as to enrich the references of the invention.
Passing on of “the teaching” of professionals in the health, food and other sectors that can contribute directly or indirectly to “reversing” obesity and so-called “chronic” illnesses.

1. A method for structuring balanced and varied meals, wherein a database is constructed in a computer by having a (or several) specialist(s) code each dish finalized as a function of the properties of its constituents, these properties being defined and allotted by the specialist(s) who takes (take) into consideration the characteristics of the target consumer(s), the database comprising a whole variety of dishes which will be available during a period relating to the season, as well as the characteristics of their constituents, then the computer selects from this database, for each meal, from among the available dishes, those complying with the food restrictions relating to this (or these) consumer(s) while making it possible to construct a balanced meal, and the consumer chooses from among these dishes those that he or she prefers.

2. The method as claimed in claim 1, wherein first a database of recipes, dishes and meals is constructed by carrying out the following steps:
a specialist codes the culinary properties of the ingredients usable in recipes and their possibilities of association with other ingredients or the ingredients of other recipes,
a specialist codes the proportions of the various ingredients of the recipes, the cost of the ingredients of these recipes and the preparation times,
a specialist codes the various dishes produced on the basis of elementary recipes or complex recipes, the resulting code comprising at least one item of information about nutrition and availability and the possible associations with respect to the other dishes of one and the same meal,
a specialist codes typical meals on the basis of a major component or dish,
a referential database is thus obtained and stored in a computer, and thereafter:
the consumer(s) is (are) authenticated by the computer,
a filter defining the requirements of the consumer(s) and constraints is created by this computer,
the filter is applied by the computer to the database,
the computer offers the consumer thus authenticated a choice of dishes meeting said constraints of the consumer(s) and optimized in terms of dietary and nutritional values.

3. The method as claimed in claim 1, wherein the database is constructed with the aid of the expertise of specialists in nutrition.

4. The method as claimed in claim 1, wherein the selection of dishes from the database is subordinated to the consideration of prior information comprising at least one of the following items of information: country, region, date of meal, type of meal, number of meals for omnivores, number of meals for vegetarians, restrictions (because of beliefs, taste or allergies), group of individuals.

5. The method as claimed in claim 3, wherein the choice of the main dish of the meal determines the subsequent selections.

6. The method as claimed in claim 3, wherein the selections and choices are interdependent.

7. The method as claimed in claim 6, wherein, when a selection is canceled, all the succeeding selections are canceled.

8. The method as claimed in claim 1, wherein the constraints relating to the consumer comprise at least one of the following constraints: nutritional, dietary, cost price, recommendations and therapeutic counter-indications, the user's preferences, his state of health, changes in his state of health, the record of his last n meals.

9. The method as claimed in claim 8, wherein n is equal to or greater than 8.

10. The method as claimed in claim 1, characterized in that wherein the referential database evolves as a function of at least one of the following parameters: the latest dietary, nutritional or therapeutic discoveries, new methods of preparation or cooking, changes in the availability of commodities.

11. A device for the implementation of the method as claimed in claim 1, comprising: a management center comprising a database management and expert tool associated with a database comprising a plurality of references of ingredients and of recipes of dishes for several different and varied meals and complying with various nutritional and culinary criteria, these ingredients being furnished with codes defining all their nutritional characteristics and properties, at least one terminal linked to the management center and comprising a display screen, a device for reading of user information media and a manual data entry device.

12. The device as claimed in claim 11, wherein it forms part of a network of several different inter-linked geographical sites.
